(19) United States
(12) Patent Application Publication
(10) Pub. No.: US 2026/0149247 A1
(43) Pub. Date: May 28, 2026

(54) TELESCOPIC DATA CABLE ASSEMBLY

(71) Applicants: DONGGUAN CEESING INTELLIGENT DEVICE MANUFACTURING CO., LTD, Dongguan (CN); Dongguan Ceesing Intelligent Device Manufacturing Shenzhen Branch Co., Ltd., Shenzhen (CN)

(72) Inventors: ZHAN-XING LIN, Shenzhen (CN); SHENG-WEI ZHANG, Shenzhen (CN); GUANG-BIN LI, Shenzhen (CN)

(21) Appl. No.: 19/456,156

(22) Filed: Jan. 22, 2026

Related U.S. Application Data
(63) Continuation-in-part of application No. 19/063,360, filed on Feb. 26, 2025.
Application No. 19/063,360 is a continuation-in-part of application No. PCT/CN2023/135230, filed on Nov. 29, 2023.

(30) Foreign Application Priority Data
Dec. 12, 2022 (CN) 202211590092.4
Dec. 12, 2022 (CN) 202223330313.2
Apr. 12, 2023 (CN) 202310393398.9

(51) Int. Cl. H02G 3/04

(52) U.S. Cl. CPC H02G 3/0456

(57) ABSTRACT

A telescopic data cable assembly includes a rotating conductive assembly and a data cable electrically connected to the rotating conductive assembly. The rotating conductive assembly includes a plane slip ring and a first limit plate. The plane slip ring includes a structural support and a plurality of conductive members located on the structural support. The first limit plate defines a slide groove extending along a rotation trajectory of the conductive members, and the conductive members are configured to abut against the slide groove. The plane slip ring or the first limit plate rotates when the data cable is stretched. The structural support includes a limit ring and an extension section extending from the limit ring, and the conductive members is arranged on the extension section. Each conductive member includes a contact portion for electrical contact with external components.

### CROSS-REFERENCE TO RELATED APPLICATION

This application claims all benefits accruing under 35 U.S.C. § 119 from China Patent Application No. 202211590092.4, filed on Dec. 12, 2022, China Patent Application No. 202310393398.9, filed on Apr. 12, 2023, and China Patent Application No. 202223330313.2, filed on Dec. 12, 2022, in the China National Intellectual Property Administration, the content of which is hereby incorporated by reference. This application is a continuation-in-part under 35 U.S.C. § 120 of U.S. application Ser. No. 19/063360 filed on Feb. 26, 2025, which is a continuation-in-part of international patent application PCT/CN 2023/135230 filed Nov. 29, 2023, and the content of which is hereby fully incorporated by reference.

### TECHNICAL FIELD

The present disclosure relates to the technical field of electronic accessories, and in particular to a plane slip ring, a rotating conductive assembly and a telescopic data cable assembly.

### BACKGROUND

A charging cable of an existing charging device may be long, causing the charging cable inconveniently to be stored. Therefore, some charging devices have been developed, which incorporate coiling mechanisms to roll up the charging cables, so that the charging cables can be stretched and retracted by user as needed. However, the electrical connection between the charging cable and a circuit board inside the electronic device may be poor after repeated stretching and retracting of the charging cable.

### SUMMARY

In view of the above short-comings, a telescopic data cable assembly is provided in the present disclosure.

The telescopic data cable assembly includes a rotating conductive assembly and a data cable electrically connected to the rotating conductive assembly. The rotating conductive assembly includes a plane slip ring and a first limit plate. The plane slip ring includes a structural support and a plurality of conductive members located on the structural support. The first limit plate includes a slide groove extending along a rotation trajectory of the plurality of conductive members. The plurality of conductive members is configured to abut against and electrically connected to a bottom of the slide groove. The plane slip ring or the first limit plate of the rotating conductive assembly is configured to rotate when the data cable is stretched. The structural support includes a limit ring and an extension section extending from an outer periphery of the limit ring. The plurality of conductive members is arranged on the extension section. Each of the plurality of conductive members comprises a contact portion configured for electrical contracting with external components, and the contact portion includes a contact point.

Other aspects and embodiments of the present disclosure are also expected. The above summary and the following detailed description are not intended to limit the present disclosure to any particular embodiment, but are merely intended to describe some embodiments of the present disclosure.

### BRIEF DESCRIPTION OF THE DRAWINGS

In order to more clearly illustrate the technical solutions of the embodiments of the present disclosure, the drawings needed to be used in the description of the embodiments will be briefly introduced below. Obviously, the drawings in the following description are some embodiments of the present disclosure. Those of ordinary skill in the art can also obtain other drawings based on these drawings without exerting creative work.

FIG. 1 is a schematic diagram of a perspective structure view of a plane slip ring provided in a first embodiment according to the present disclosure.

FIG. 2 is a schematic diagram of a structure of a conductive member and a pin of the plane slip ring provided in the first embodiment.

FIG. 3 is another schematic diagram of a structure of a limit ring of the plane slip ring provided in the first embodiment.

FIG. 4 is a third schematic diagram of a perspective structure view of the plane slip ring provided in the first embodiment.

FIG. 5 is a schematic diagram of a perspective structure view of a rotating conductive assembly provided in a second embodiment according to the present disclosure.

FIG. 6 is a schematic diagram of a conductive circuit of a second limit plate of the rotating conductive assembly provided in the second embodiment.

FIG. 7 is a schematic diagram of a conductive circuit of a first limit plate of the rotating conductive assembly provided in the second embodiment.

FIG. 8 is a schematic diagram of a perspective structure view of a telescopic data cable assembly provided in a third embodiment according to the present disclosure.

FIG. 9 is schematic diagram of a perspective structure view of a telescopic data cable assembly provided in a fourth embodiment according to the present disclosure.

FIG. 10 is a cross-sectional view of the telescopic data cable assembly along line V-V of FIG. 9.

In the drawings, the parts represented by each number are listed as follows:
1. plane slip ring; 2. rotating conductive assembly; 3. telescopic data cable assembly;
11. structural support; 12. conductive member; 13. pin; 21. limit plate; 31. data cable;
111. limit ring; 112. extension section; 121. contact portion; 122. abutment structure; 211. first limit plate; 212. second limit plate;
1111. annular protrusion; 1121. receiving groove; 1122. partition plate; 1123. connecting groove; 1221. contact point; 2111. limit protrusion; 2112. slide groove.

### DETAILED DESCRIPTION

The technical solutions in the embodiments of the present disclosure will be clearly and completely described below with reference to the accompanying drawings in the embodiments of the present disclosure. Obviously, the described embodiments are part of the embodiments of the present disclosure, rather than all of the embodiments. Based on the embodiments in the present disclosure, all other embodiments obtained by those of ordinary skill in the art without creative efforts fall within the scope of protection of the present disclosure.

It should be noted that the terms “first” and “second” and the like in the specification and claims of the present disclosure are used to distinguish different objects rather than to describe a specific order.

It should be noted that when an element is referred to as being “fixed” to another element, it can be directly on the other element or intervening elements may also be present. When an element is referred to be “connected” to another element, it can be directly connected to the other element or there may also be intervening elements present. The terms “vertical,” “horizontal,” “left,” “right,” and similar expressions are used herein for illustrative purposes only.

In the present disclosure, the terms “upper”, “lower”, “left”, “right”, “front”, “rear”, “top”, “bottom”, “inner”, “outer”, “middle”, “vertical”, “horizontal”, “lateral”, “longitudinal” and the like indicate positions or positional relationships based on the positions or positional relationships shown in the accompanying drawings. These terms are mainly used to better describe the present disclosure and its embodiments, and are not used to limit the indicated devices, elements or components to have a specific orientation, or to be constructed and operated in a specific orientation.

In addition, in addition to being used to indicate an orientation or positional relationship, some of the above terms may also be used to indicate other meanings. For example, the term “upper” may also be used to indicate a certain dependency or connection relationship in some cases. For those of ordinary skill in the art, the specific meanings of these terms in the present disclosure can be understood according to the specific circumstances.

In addition, the terms “installed”, “set”, “provided with”, and “connected” should be understood in a broad sense. For example, it can be a fixed connection, a detachable connection, or an integral structure; it can be a mechanical connection or an electrical connection; it can be a direct connection, or an indirect connection through an intermediate medium, or it can be an internal connection between two devices, elements or components. For those of ordinary skill in the art, the specific meanings of the above terms in the present disclosure can be understood according to the specific circumstances.

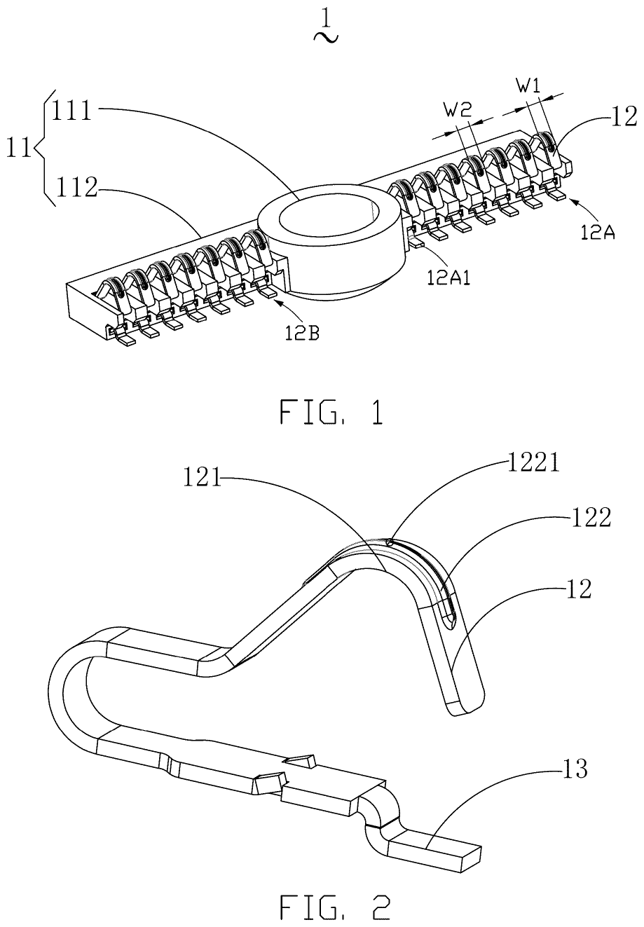

Please refer to FIGS. 1 and 2. A first embodiment of the present disclosure provides a plane slip ring 1 for ensuring a stable electrical connection with a PCB board during rotation. The plane slip ring 1 includes a structural support 11 and a plurality of conductive members 12 arranged on the structural support 11. The structural support 11 includes a limit ring 111 and an extension section 112 extending radially along the limit ring 111. The conductive member 12 is arranged on the extension section 112 and includes a contact portion 121 for electrically contacting other external components. The contact portion 121 is formed with a contact point 1221. The contact point 1221 of each conductive member 12 is coplanar and located on the same straight line. In one embodiment, the extension section 112 is axially or centrally symmetrical with respect to the limit ring 111. Thus, a centrifugal force during the rotation of the plane slip ring 1 may be balanced to prevent any deviation of the plane slip ring 1 from a desired position due to high-speed frequent rotation.

In one embodiment, the conductive members 12 are divided into several groups. Each conductive member 12 in one group of conductive members 12 can perform a specific function, and the conductive members 12 in the several groups of conductive members 12 for performing a same function are electrically connected to each other. In one embodiment, the several groups of conductive members 12 may include a multifunctional conductive group 12A and a conventional conductive group 12B. The multifunctional conductive group 12A includes a multifunctional conductive member 12A1. The multifunctional conductive member 12A1 can be used to monitor the motion state of the data cable 31, such as a moving speed, a moving length, or a moving direction of the data cable 31.

In one embodiment, for each group of conductive members 12, a width W1 of the conductive members 12 located on two sides is greater than a width W2 of the conductive members 12 located in the middle position. In one embodiment, the width of the conductive members 12 ranges from 0.2 mm to 0.8 mm, and the length of the conductive members 12 ranges from 4 mm to 10 mm. Within the above range, the conductive member 12 can maintain a certain rigidity and elasticity while avoiding an over large of size of a telescopic data cable assembly 3 (shown in FIG. 8 to 10), such that stable electrical connection can be ensured during rotation.

It should be noted that the structural shape of the limit ring 111 is not limited and is not required to be configured as a circular-ring shape. To facilitate rotation, the inner wall of the limit ring 111 is usually circular, which can be abutted with a matching structure to fix the position of the plane slip ring 1 and can rotate while fitting with the inner wall of the limit ring 111. In one embodiment, as shown in FIG. 10, the limit ring 111 has a circular-ring shape or an arc-ring shape, and is designed to surround an outer periphery of a central positioning portion 32 of the telescopic data cable assembly 3. An interior of the central positioning portion 32 may define a cylindrical groove 320, and a rotation shaft 33 is inserted into the cylindrical groove 320 of the central positioning portion 32 of the telescopic data cable assembly 3. The outer periphery of the central positioning portion 32 is cylindrical, and since the limit ring 111 surrounds the outer periphery of the central positioning portion 32, stable rotational connection can be ensured during the movement of the data cable 31.

Specifically, in a specific embodiment of the present disclosure, the limit ring 111 is configured as a circular-ring shape, and there is a certain thickness between the inner and outer walls thereof to ensure the mechanical properties of the limit ring 111. The extension section 112 is integrally formed with the limit ring 111 and extends in opposing directions.

It can be understood that through the above arrangement, the limit ring 111 can limit the position of the plane slip ring 1 and can rotate around the limit ring 111. The symmetrically arranged extension section 112 can maintain balanced forces at both ends thereof during rotation, thereby reducing the wear of the plane slip ring 1 when interacting with other components and increasing the service life. The contact portion 121 of the conductive member 12 is convenient for abutting against other components, and the contact points of the contact portions 121 are in the same straight line to ensure the overall coaxiality, making the rotation process of the plane slip ring 1 more stable.

Further, the extension section 112 includes at least two sections, which are axially symmetrical or centrally symmetrical on both sides of the limit ring 111.

In one embodiment, the conductive members 12 in one of the groups of conductive members are evenly spaced from each other on the extension section 112, and are arranged on a same side of the limit ring 111 along an axial direction of the limit ring 111.

It should be noted that “the same side” refers to the same side along the axial direction of the limit ring 111, rather than the same side along the radial direction of the extension section 112, that is, the conductive members 12 on the same side of the extension section 112 are preferentially ensured to be coplanar, and then in the case of coplanarity, the coaxiality is ensured by limiting the position of the conductive members 12 and adjusting the contact points 1221. In order to ensure the coaxiality of the conductive members 12 arranged thereon and the balanced stress condition of the overall structure of the plane slip ring 1, the extension sections 112 are symmetrically arranged in pairs, therefore, the total number of the extension sections 112 is not limited and can be an even number. If the coaxiality does not need to be met, the number of the extension sections 112 can be an odd number such as three or five, which meets the central symmetry to balance the stress on the plane slip ring 1.

Specifically, in the embodiment of the present disclosure, the number of the extending sections 112 is two, and the conductive members 12 are arranged on the same side of the extending sections 112 and on the same straight line.

It can be understood that through this arrangement, the conductive members 12 are symmetrically and spaced apart on the extension sections 112, and the extension sections 112 are axially symmetrically and centrally symmetrically arranged on both sides of the limit ring 111. When working, the conductive members 12 on the extension sections 112 will abut against and slide relatively with other components, and the friction forces received are the same, thereby ensuring the balance and stability of the rotation of the plane slip ring 1. In addition, when the conductive members 12 on the extension sections 112 rotate, the line connecting the contact points 1221 and the center of rotation are always on the same straight line, further ensuring the balance and stability of the plane slip ring 1 during rotation.

Further, the conductive member 12 is partially bent to form a contact portion 121, and an abutment structure 122 is provided on the curved surface of the contact portion 121. The abutment structure 122 forms a contact point 1221 at a position where the curved surface is in electrical contact with other external components.

Specifically, the contact portion 121 is in an arc shape, the arc is bent away from the extending section 112, and the abutment structure 122 is disposed on the arc surface of each contact portion 121.

It should be noted that the conductive members 12 are made of metal and can conduct electricity, and the abutment structure 122 is provided to improve the

### Conductivity Thereof.

It can be understood that through the above arrangement, the contact portion 121 of the conductive member 12 can easily abut against other components. The arc shape of the contact portion 121 can reduce a certain contact area, and the contact surface is smoother, which ensures the smoothness of the conductive member 12 during the abutment and sliding process, thereby making the rotation process of the plane slip ring 1 more stable. The abutment structure 122 can serve as an intermediate layer to connect the conductive member 12 and abut against other components, thereby enhancing contact, reducing impedance, and ensuring better conductive performance.

Specifically, in a specific embodiment of the present disclosure, the conductive member 12 is a metal spring. In addition, to ensure that the conductive members 12 are on the same straight line, the arcs of the contact portions 121 need to be controlled to have the same specifications, and the centers of the circles of the arcs are on the same straight line, such that the contact points 1221 of each conductive member 12 are at the same height. Specifically, the specifications of the arcs are not limited here and are subject to actual needs.

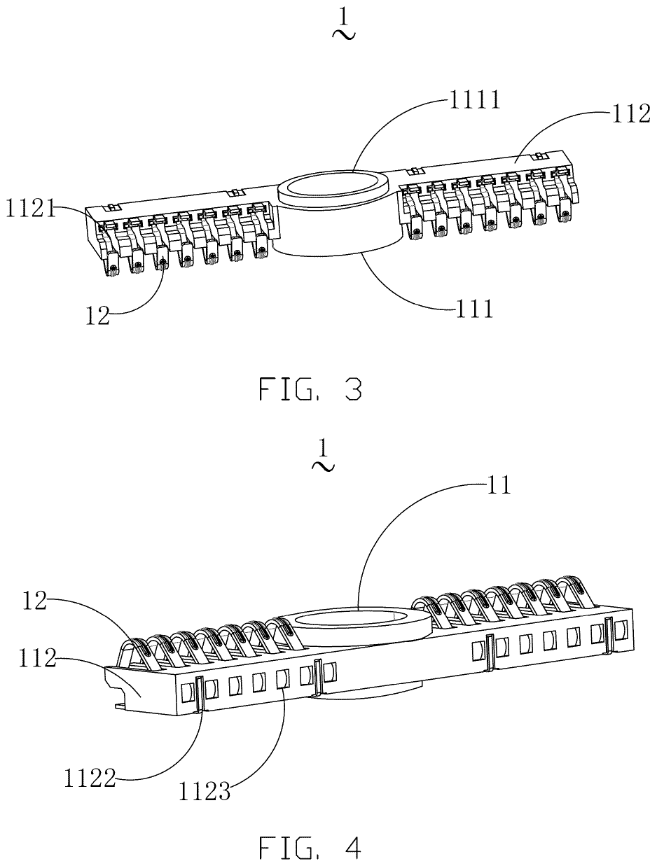

Further, please refer to FIG. 2 and FIG. 3. The plane slip ring 1 further includes a plurality of pins 13 electrically connected to the conductive members 12, and a plurality of receiving grooves 1121 for receiving the conductive members 12 and the pins 13 are formed on the extension section 112. The receiving grooves 1121 electrically isolates the conductive members 12 from each other.

It should be noted that the pin 13 is connected to one end of the conductive member 12 embedded in the receiving groove 1121, and the pin 13 is jointly embedded in the receiving groove 1121. The receiving groove 1121 can fix the conductive member 12 and the pin 13. The other end of the pin 13 extends from the receiving groove 1121 for connecting the data cable 31. This ensures the electrical connection between the pin 13 and the conductive member 12 to realize the transmission of electrical signals. In addition, this ensures the firm fixation of the conductive member 12 and the pin 13 to prevent the pin 13 and/or the conductive member 12 from falling off due to external force or friction during use or rotation, which may reduce the service life of the plane slip ring 1.

It can be understood that through the above arrangement, the pin 13 and the conductive member 12 form a simple circuit loop, the pin 13 is used to electrically connect to the data cable 31 to obtain electrical signals and transmit the electrical signals through the conductive member 12 or receive electrical signals transmitted by components or devices electrically connected to the conductive member 12 and transmit them to the data cable 31.

Specifically, the conductive member 12 and the pin 13 are embedded in the receiving groove 1121 and both partially protrude from the receiving groove 1121.

It should be noted that the receiving grooves 1121 are arranged on the extension section 112 at intervals along with the conductive members 12, and the width of the receiving grooves 1121 corresponds to the width of the conductive members 12.

It can be understood that, through the above arrangement, the conductive member 12 is embedded in the receiving groove 1121, which makes the structure simpler, and the production and processing more convenient.

In addition, one end of the conductive member 12 is embedded in the receiving groove 1121, and the other end thereof is overhead with the contact portion 121. In a specific embodiment of the present disclosure, the overhead end of the conductive member 12 is received in the receiving groove 1121 to protect the conductive member 12 and reduce the space occupancy rate of the conductive member 12.

It can be understood that the arc-shaped overhead portion of the conductive member 12 can effectively and automatically adjust the abutting position and abutting pressure of the conductive member 12 when it abuts against other components.

Further, each pair of electrically connected pins 13 and conductive members 12 are integrally formed or spliced together. In one embodiment, each pair of electrically connected pins 13 and conductive members 12 are integrally formed.

Specifically, a connecting groove 1123 connecting the receiving groove 1121 and the outer side of the structural support 11 is provided on the structural support 11. The connecting grooves 1123 are provided on the opposite side of the extension direction of the pins 13 on the structural support 11. The user can confirm the connection status of the pins 13 and the conductive members 12, as well as the embedded status of the pins 13 and the conductive members 12 in the receiving groove 1121 through the connecting grooves 1123.

Further, refer to FIG. 3 and FIG. 4. The side of the limit ring 111 close to the conductive member 12 protrudes from the structural support 11, and the protruding height thereof is less than the height of the vertex of the contact portion 121 of the conductive member 12.

It can be understood that, through the above arrangement, the stability of the connection between the plane slip ring 1 and other components can be increased, and the height limitation can prevent the limit ring 111 from rubbing against other components, which may affect the smoothness of the rotation of the plane slip ring 1.

Further, an annular protrusion 1111 that forms a concentric ring structure with the limit ring 111 is provided on a side of the limit ring 111 away from the conductive member 12 forming the contact portion 121.

Further, the side wall defining the limit ring 111 and the annular protrusion 1111 close to the conductive member 12 is the outer side wall, and the side wall opposite to the outer wall is the inner side wall. The inner side wall of the annular protrusion 1111 is in the same plane as the inner side wall of the limit ring 111. The diameter between the inner and outer side walls of the annular protrusion 1111 is less than the diameter between the inner and outer side walls of the limit ring 111, that is, the thickness between the inner and outer side walls of the annular protrusion 1111 is less than the thickness between the inner and outer side walls of the limit ring 111.

It should be noted that the annular protrusion 1111 is arranged close to the inner side wall of the limit ring 111, such that the inner side wall of the annular protrusion 1111 and the inner side wall of the limit ring 111 are in the same plane.

It can be understood that through the above arrangement, the inner side wall of the annular protrusion 1111 and the inner side wall of the limit ring 111 are on the same plane, making the overall structure simpler. The annular protrusion 1111 can cooperate with other components for further limiting, further ensuring the stability of the connection.

Furthermore, a partition plate 1122 is also provided on the structural support 11.

It should be noted that the position of the partition plate 1122 is not limited, as long as it is symmetrically arranged on the extension section 112. Specifically, in a specific embodiment of the present disclosure, the partition plate 1122 is disposed at the position of the first conductive member 12 in the direction in which the extension section 112 extends from the limit ring 111, and is disposed again at intervals of five conductive members 12.

It can be understood that the partition plate 1122 is used to limit the interval of the conductive member 12 and the position of the limit ring 111 and the conductive member 12, as well as add a certain counterweight to ensure the reliability of the plane slip ring 1 during rotation.

Please refer to FIGS. 4 and 5. The present disclosure further provides a rotating conductive assembly 2 to solve the technical problem, including the above-mentioned plane slip ring 1 and a limit plate 21 adapted to the plane slip ring 1. The limit plate 21 is provided with a limit protrusion 2111 adapted to the limit ring 111. The plane slip ring 1 can complete the rotation through the cooperation between the limit ring 111 and the limit protrusion 2111. The rotating conductive assembly 2 has the same beneficial effects as the above-mentioned plane slip ring 1, which will not be described in detail here.

It should be noted that the number of the limit plate 21 is generally configured as two, and the plane slip ring 1 is placed between the two limit plates 21 to assist in rotation or resetting. The limit plate 21 close to the conductive member 12 is as described above, and the limit plate 21 away from the conductive member 12 is designed according to actual needs or the corresponding structure of the plane slip ring 1 to ensure the normal implementation of the function.

Further, the limit plate 21 includes a first limit plate 211 and a second limit plate 212, and the plane slip ring 1 is disposed on the second limit plate 212. The plane slip ring 1 rotates in cooperation with the first limit plate 211 via the limit ring 111.

Further, a slide groove 2112 corresponding to the contact portion 121 of the conductive member 12 is formed on the first limit plate 211 of the rotating conductive assembly 2. The slide groove 2112 is formed along the rotation trajectory of the corresponding conductive member 12. The conductive member 12 abuts against and is electrically connected to the bottom of the slide groove 2112.

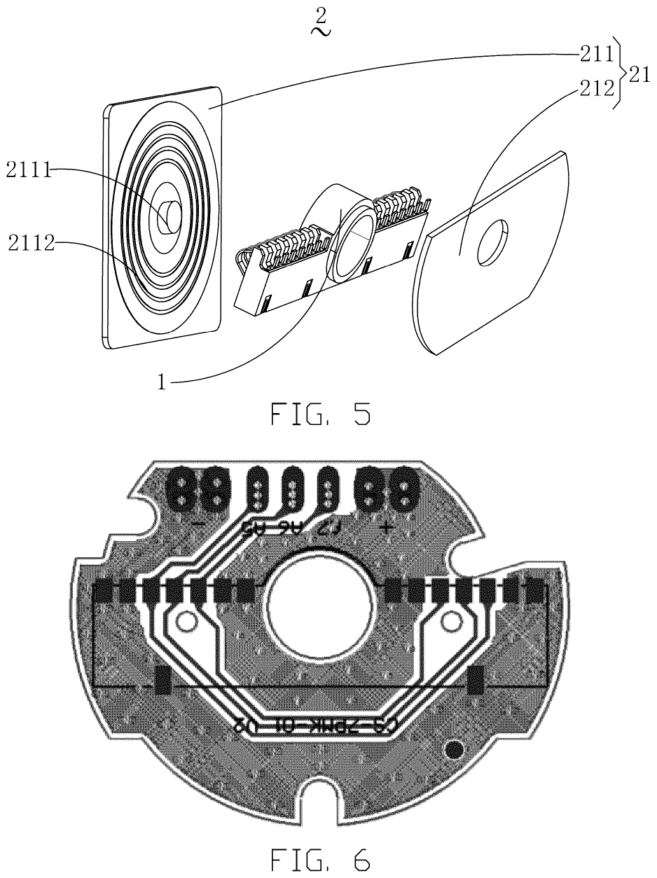

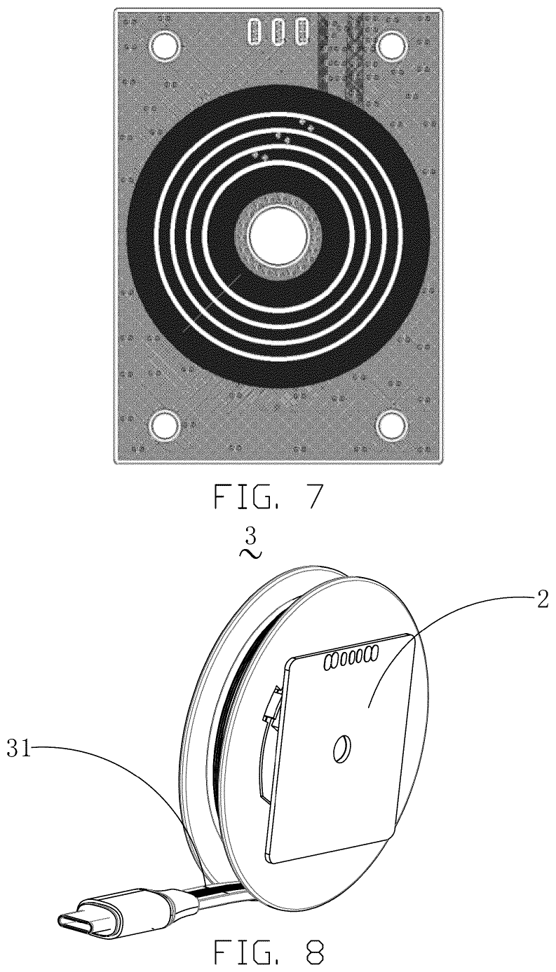

Specifically, please refer to FIG. 6 and FIG. 7. FIG. 6 is a schematic diagram of the circuit of the second limit plate 212, and FIG. 7 is a schematic diagram of the circuit of the first limit plate 211.

It can be understood that, through the above arrangement, when the plane slip ring 1 rotates, the conductive member 12 can move in the slide groove 2112, and always maintain an electrical connection with the bottom of the slide groove 2112, so as to facilitate the transmission of electrical signals.

Referring to FIG. 10, in other embodiments, the first limit plate 211 includes a limit portion 2113, which is circular or arc-shaped. The limit portion 2113 is used to surround an outer periphery of the central positioning portion 32 of the telescopic data cable assembly 3. An interior of the central positioning portion 32 may define a cylindrical groove 320, and a rotation shaft 33 is inserted into the cylindrical groove 320 of the central positioning portion 32 of the telescopic data cable assembly 3. The outer periphery of the central positioning portion 32 is cylindrical, and since the limit portion 2113 surrounds the outer periphery of the central positioning portion 32, a stable rotational connection can be ensured during the movement of the data cable 31.

Please refer to FIG. 8. The present disclosure further provides a telescopic data cable assembly 3 including the rotating conductive assembly 2 as described above. The telescopic data cable assembly 3 also includes a data cable 31 electrically connected to the rotating conductive assembly 2. When the data cable 31 is stretched, the plane slip ring in the rotating conductive assembly 2 is driven to rotate. The telescopic data cable assembly 3 has the same beneficial effects as the rotating conductive assembly 2 as described above, which will not be described in detail here.

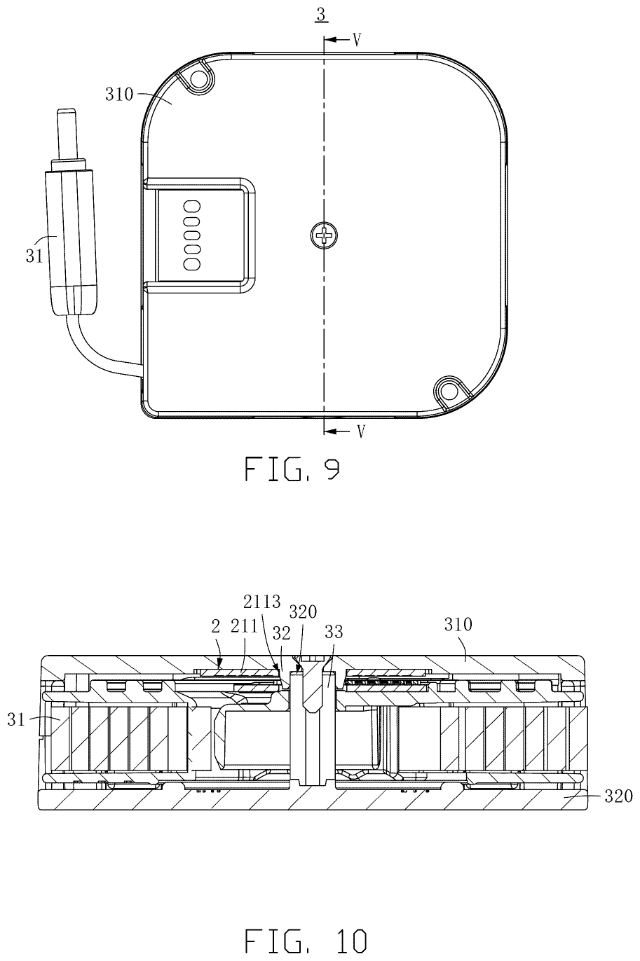

Referring to FIGS. 9 and 10, in another embodiment, the telescopic data cable assembly 3 further includes a first shell 310 and a second shell 320. The first shell 310 and the second shell 320 cooperatively define a space for receiving the rotating conductive assembly 2. The central positioning portion 32 is provided on a surface of the first shell 310 facing the second shell 320. The rotation shaft 33 is located between the first shell 310 and the second shell 320.

The above description is only a preferred embodiment of the present disclosure and is not intended to limit the present disclosure. Any modifications, equivalent substitutions and improvements made within the principles of the present disclosure should be included in the protection scope of the present disclosure.

What is claimed is:

1. A telescopic data cable assembly, comprising:
a rotating conductive assembly; and
a data cable electrically connected to the rotating conductive assembly;
the rotating conductive assembly comprising:
a plane slip ring comprising a structural support and a plurality of conductive members located on the structural support; and
a first limit plate comprising a slide groove extending along a rotation trajectory of the plurality of conductive members, wherein the plurality of conductive members is configured to abut against and electrically connected to a bottom of the slide groove, and the plane slip ring or the first limit plate of the rotating conductive assembly is configured to rotate when the data cable is stretched;
wherein the structural support comprises a limit ring and an extension section extending from an outer periphery of the limit ring, the plurality of conductive members is arranged on the extension section, each of the plurality of conductive members comprises a contact portion configured for electrical contracting with external components, and the contact portion comprises a contact point.

2. The telescopic data cable assembly of claim 1, wherein the limit ring has a circular-ring shape or an arc-ring shape, the limit ring surrounds an outer periphery of a central positioning portion of the telescopic data cable assembly, and the outer periphery of the central positioning portion is cylindrical; an interior of the central positioning portion defines a cylindrical groove, and a rotation shaft of the telescopic data cable assembly is inserted into the cylindrical groove.

3. The telescopic data cable assembly of claim 1, wherein the first limit plate comprises a limit portion, the limit portion is circular-shaped or arc-shaped, the limit portion surrounds an outer periphery of a central positioning portion of the telescopic data cable assembly, and the outer periphery of the central positioning portion is cylindrical; an interior of the central positioning portion defines a cylindrical groove, and a rotation shaft of the telescopic data cable assembly is inserted into the cylindrical groove.

4. The telescopic data cable assembly of claim 1, wherein the extension section and the limit ring are integrally formed.

5. The telescopic data cable assembly of claim 1, wherein the contact point of each of the plurality of conductive members is on a same plane and on a same straight line.

6. The telescopic data cable assembly of claim 1, wherein the extension section is axially or centrally symmetrical with respect to the limit ring.

7. The telescopic data cable assembly of claim 1, wherein the plane slip ring further comprises a plurality of pins, each of the plurality of pins is electrically connected to a corresponding one of the plurality of conductive members, the extension section defines a plurality of receiving grooves for receiving the plurality of conductive members and the plurality of pins, and the plurality of receiving grooves electrically isolates the plurality of conductive members from each other.

8. The telescopic data cable assembly of claim 7, wherein each of the plurality of conductive members and each of the plurality of pins partially protrude from a corresponding one of the plurality of receiving grooves.

9. The telescopic data cable assembly of claim 7, wherein each of the plurality of conductive members is integrally formed with a corresponding one of the plurality of pins connected thereto.

10. The telescopic data cable assembly of claim 1, wherein each of the plurality of conductive members is partially bent to form the contact portion, an abutment structure is provided on a curved surface of the contact portion; the abutment structure forms the contact point at a position where the curved surface is in electrical contact with the external components.

11. The telescopic data cable assembly of claim 10, wherein the contact portion is in a form of an arc, the arc is bent away from the extending section, and the abutment structure is arranged on an arc surface of the contact portion.

12. The telescopic data cable assembly of claim 1, wherein the plurality of conductive members is divided into a plurality of groups of conductive members, each conductive member in one of the plurality of groups of conductive members is configured to perform a function, and the conductive members in the plurality of groups of conductive members for performing a same function are electrically connected to each other.

13. The telescopic data cable assembly of claim 12, wherein the conductive members in one of the plurality of groups of conductive members are evenly spaced from each other on the extension section, and are arranged on a same side of the limit ring along an axial direction of the limit ring.

14. The telescopic data cable assembly of claim 12, wherein in each of the plurality of groups of conductive members, and a width of the conductive members located on two sides is greater than a width of the conductive members located in a middle position.

15. The telescopic data cable assembly of claim 1, wherein the plurality of conductive members is divided into a plurality of groups of conductive members, the plurality of groups of conductive members comprises a multifunctional conductive group and a conventional conductive group, the multifunctional conductive group comprises a multifunctional conductive member configured to monitor a motion state of the data cable.

16. The telescopic data cable assembly of claim 1, wherein a width of each of the plurality of conductive members ranges from 0.2 mm to 0.8 mm.

17. The telescopic data cable assembly of claim 1, wherein a length of each of the plurality of conductive members ranges from 4 mm to 10 mm.
